(19) United States
(12) Patent Application Publication
(10) Pub. No.: US 2011/0109063 A1
(43) Pub. Date: May 12, 2011

(54) TOWING HITCH CROSS-MEMBER ASSEMBLY WITH SELF-LOCATING TABS

(76) Inventors: Chris J. Fudala, Macomb, MI (US); Robert W. Ruby, Clarkston, MI (US)

(21) Appl. No.: 12/916,156

(22) Filed: Oct. 29, 2010

Related U.S. Application Data
(60) Provisional application No. 61/256,798, filed on Oct. 30, 2009.
(60) Provisional application No. 61/256,780, filed on Oct. 30, 2009.

(51) Int. Cl. B60D 1/14

(52) U.S. Cl. 280/497

(57) ABSTRACT

A cross-member assembly for use with a hitch for a vehicle, said cross-member assembly can include an elongate cross-member having a first distal end and a second distal end, and at least one notch disposed on at least one of the first distal end and the second distal end. The notch is configured to be matingly engaged with at least one protuberance disposed on a mounting member when one of the first and the second distal ends of the cross-member is received by the mounting member. The mounting member can have an aperture configured to receive one of the first and second distal ends, and the protuberance can be formed on the aperture. The assembly can also have a slotted cross-member.

### CROSS-REFERENCE TO RELATED APPLICATIONS

This application claims the benefit of U.S. Provisional Application No. 61/256,798 filed Oct. 30, 2009, and U.S. Provisional Application No. 61/256,780 filed Oct. 30, 2009.

### FIELD OF TECHNOLOGY

The present disclosure relates generally to vehicle hitches. More specifically, the present disclosure relates to a cross-member assembly having self-locating tabs for a vehicle towing hitch.

### BACKGROUND

A variety of accessories are available for mounting to vehicles. For example a vehicle hitch can be mounted on to the rear of a vehicle to facilitate pulling or towing of general purpose trailers, other motor vehicles, camper-trailer combinations and trailer homes and the like. These hitches can generally have a cross-member or a crossbar positioned substantially at the rear of the vehicle. There are a variety of vehicle hitches that include gooseneck hitches, receiver hitches, and ball-type hitches. Additionally, hitches are grouped into classes or categories depending on the amount of load the hitch can handle. For example, Class I and Class II hitches can handle load of up to 2,000 pounds. Class III and class IV hitches can handle loads up to 5,000 pounds. Class V hitches can handle loads greater than 10,000 pounds.

Vehicle hitches are typically constructed from heavy metal material, such as steel because the hitches are designed to withstand large loads. Additionally, the hitches are typically formed from an assembly of components joined together by welding. Due to the size and weight of the components, it can be difficult to manipulate and piece together the components during assembly of the hitch. For example, the hitch can include mounting brackets and a cross-member. During assembly, the mounting brackets are held in place against the cross-member and tack welds are made where the mounting brackets meet the cross-member. The tack welds are made to hold the hitch components in place so that a final weld can be made to complete the assembly of the vehicle hitch. This additional step of preliminarily securing the alignment of the hitch components before a final weld can be completed results in increased assembly time. Additional equipment or manpower may be required to hold the hitch components in place while a tack weld is made. Furthermore, the components must be in proper alignment when the tack weld is made. If the components are incorrectly aligned, the parts may need to be disassembled, realigned, and tack welded again. In other situations, the tack weld can rupture before the final weld is made if the components are not properly clamped or held together during tack welding or if the tack weld is improperly made. Thus, the assembly of vehicle hitches can be cumbersome. Accordingly, there is a need for a less cumbersome and more efficient vehicle hitch assembly and method of assembling vehicle hitches.

### BRIEF DESCRIPTION OF THE DRAWINGS

Embodiments of the present application will now be described, by way of example only, with reference to the attached Figures, wherein:

FIG. 1 is a perspective view of a hitch cross-member assembly in accordance with an exemplary embodiment in a disassembled configuration;

FIG. 2 is a perspective view of an end portion of the hitch cross-member assembly as illustrated in FIG. 1 as assembled;

FIG. 3 is an exploded view of an end portion of the hitch cross-member assembly as illustrated in FIG. 2;

FIG. 4 is perspective view of an assembled hitch cross-member assembly in accordance with an exemplary embodiment of the present disclosure having self-locating tabs;

FIG. 5 is an exploded view of an end portion of a hitch cross-member assembly in accordance with an alternative exemplary embodiment of the present disclosure having self-locating tabs;

FIG. 6 is a perspective view of an end portion of the assembled hitch cross-member assembly illustrated in FIG. 5;

FIG. 7 is a perspective view of an assembled hitch cross-member assembly in accordance with an exemplary embodiment of the present disclosure having a welded coupling;

FIG. 8 is a perspective view of an assembled hitch cross-member assembly in accordance with an exemplary embodiment of the present disclosure having an integrated receiver;

FIG. 9 is a perspective view of an assembled hitch cross-member assembly in accordance with an exemplary embodiment of the present disclosure having a welded receiver;

FIG. 10 is a perspective view of an assembled hitch cross-member assembly in accordance with an exemplary embodiment of the present disclosure having a mounted receiver;

FIG. 11 is a perspective view of an assembly cross-member assembly in accordance with an exemplary embodiment of the present disclosure having safety apertures;

FIG. 12 is a front perspective view of a towing hitch assembly having a slotted cross-member in accordance with an exemplary embodiment of the present disclosure in a disassembled configuration;

FIG. 13 is a front perspective of the towing hitch assembly as depicted in FIG. 12 in an assembled configuration;

FIG. 14 is a rear perspective view of the towing hitch assembly as depicted in FIG. 13;

FIG. 15 is front view of the towing hitch as depicted in FIG. 13;

FIG. 16 is a side view of an end portion of the towing hitch assembly as depicted in FIG. 13;

FIG. 17 is a front perspective view of a towing hitch assembly in accordance with an alternative exemplary embodiment of the present disclosure having the receiver coupled at the bottom of the cross-member;

FIG. 18 is a rear perspective view of the towing hitch assembly as depicted in FIG. 17;

FIG. 19 is a front view of the towing hitch assembly as depicted in FIG. 17;

FIG. 20 is a side view of an end portion of the towing hitch as depicted in FIG. 17;

FIG. 21 is a front perspective view of a towing hitch assembly in accordance with an alternative exemplary embodiment of the present disclosure having a square cross-member;

FIG. 22 is a front perspective view of a towing hitch assembly in accordance with an alternative exemplary embodiment of the present disclosure having a circular cross-member;

FIG. 23 is a front perspective view of a towing hitch assembly in accordance with an alternative exemplary embodiment of the present disclosure without a safety aperture;

FIG. 24 is a front perspective view of a towing hitch assembly in accordance with an alternative exemplary embodiment of the present disclosure having a reinforcement plate; and

FIG. 25 is a rear perspective view of the towing hitch assembly as depicted in FIG. 24.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein.

The following figures describe a hitch cross-member assembly. While the following description describes the hitch cross-member assembly for use with a Class I or Class II hitch, one of ordinary skill in the art will appreciate that the cross-member assembly can be used for any class or category of hitch. One of ordinary skill in the art will also appreciate that the cross-member assembly can be used for receiver-type hitches, ball mount hitches, or the like. Additionally, one of ordinary skill in the art will also appreciate that the cross-member assembly can be used for other types of assemblies in which one member abuts or adjoins another member, and the members are welded together. However, for simplicity, the following disclosure will describe a cross-member assembly for use with receiver-type hitches.

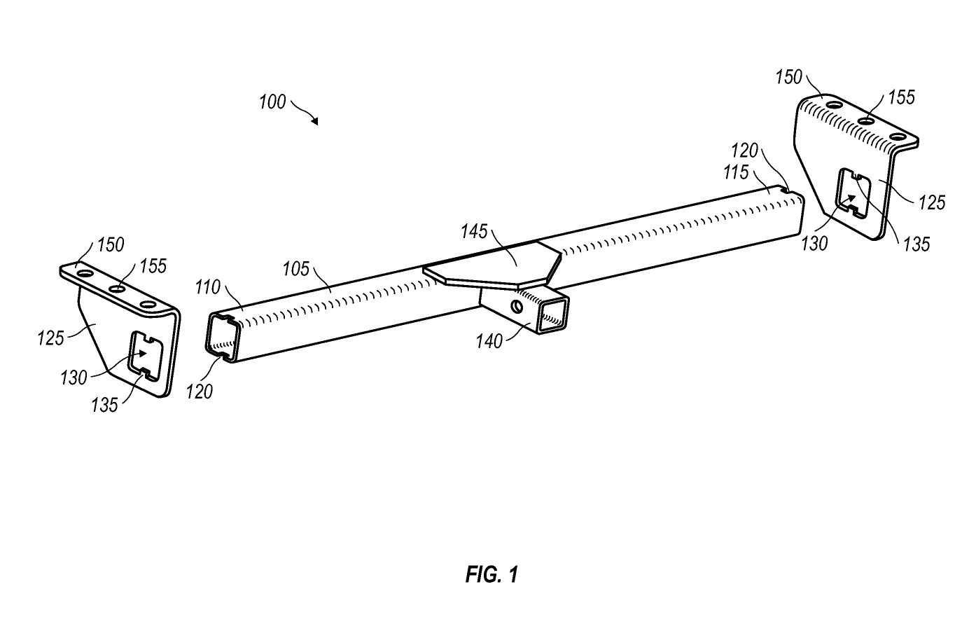

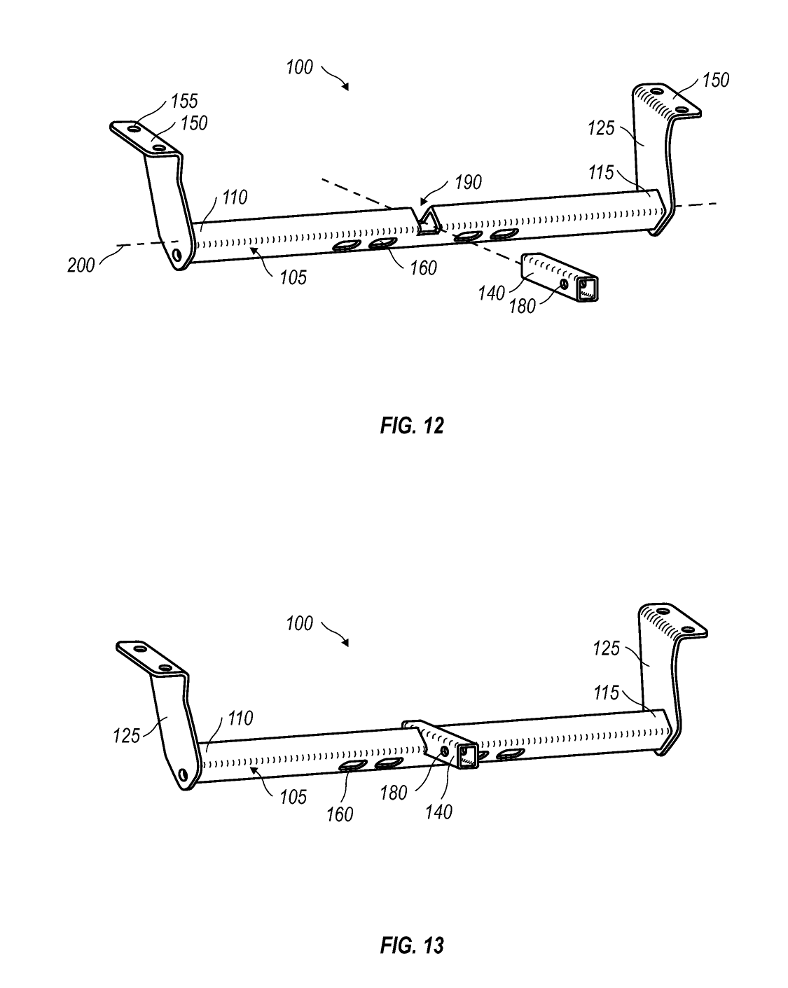

FIG. 1 is a perspective view of a hitch cross-member assembly 100 in accordance with an exemplary embodiment in a disassembled configuration. The hitch cross-member assembly 100 includes an elongate cross-member 105 and at least one mounting member 125. The cross-member 105 has a first distal end 110 and a second distal end 115. The elongate cross-member 105 can be a solid structure or a hollow structure, such as a tube. The elongate cross-member 105, while illustrated as a square cross-section, can also have various cross-sectional shapes such as a circular cross-section (shown in FIG. 22), a diamond cross-section, a triangular cross-section, or other shaped cross-section. In FIG. 1, the illustrated cross-member 105 is a hollow tube having a square cross-section that is mounted to the cross-member 105 by a mounting plate 145. In alternative embodiments, the cross-member 105 can be a straight cross-member 105 or can be a non-straight cross-member 105. For example, the cross-member 105 can have bends. In other alternative embodiments, the cross-member 105 can be a slotted cross-member, as will be described in further detail with respect to FIGS. 12-25.

In FIG. 1, the illustrated cross-member assembly 100 can also include a receiver 140 disposed between the first distal end 110 and the second distal end 115. Additionally, the receiver 140 can be a hollow square tube. However, in alternative embodiments, the receiver 140 can be a flat tongue, a flat plate, a diamond-shaped tube, a circular tube, or other similar element for attaching a trailer to the hitch. In at least one embodiment, the receiver 140 is centered between the first distal end 110 and the second distal end 115. In other embodiments, the receiver 140 can be offset from the center position. Additionally, FIG. 1 illustrates a cross-member 105 that is a made of steel. In alternative embodiments, the cross-member 105 can be made of aluminum or any other metal or material that can handle a load exerted by a trailer attached to the towing hitch assembly 100. For example, the cross-member 105 in at least one embodiment can be a carbon fiber material or other composite.

At least one notch 120 can be disposed on at least one of the first distal end 110 and the second distal end 115 of the cross-member 105. The at least one notch 120 is configured to matingly engage with a protuberance 135 disposed on a mounting member 125 when one of the first distal end 110 and the second distal end 115 is received by the mounting member 125. FIG. 1 illustrates the at least one notch 120 having a square shape. However, in alternative embodiments, the at least one notch 120 can be a slit, a slot, or can have a rounded shape, a semi-circular shape, a triangular shape, a rectangular shape, or other similar shape. As the at least one notch 120 will engage the at least one protuberance 135 of the mounting member 125 during assembly of the cross-member assembly 100, the shape of the at least one notch 120 will correspond with the shape of the protuberance 135.

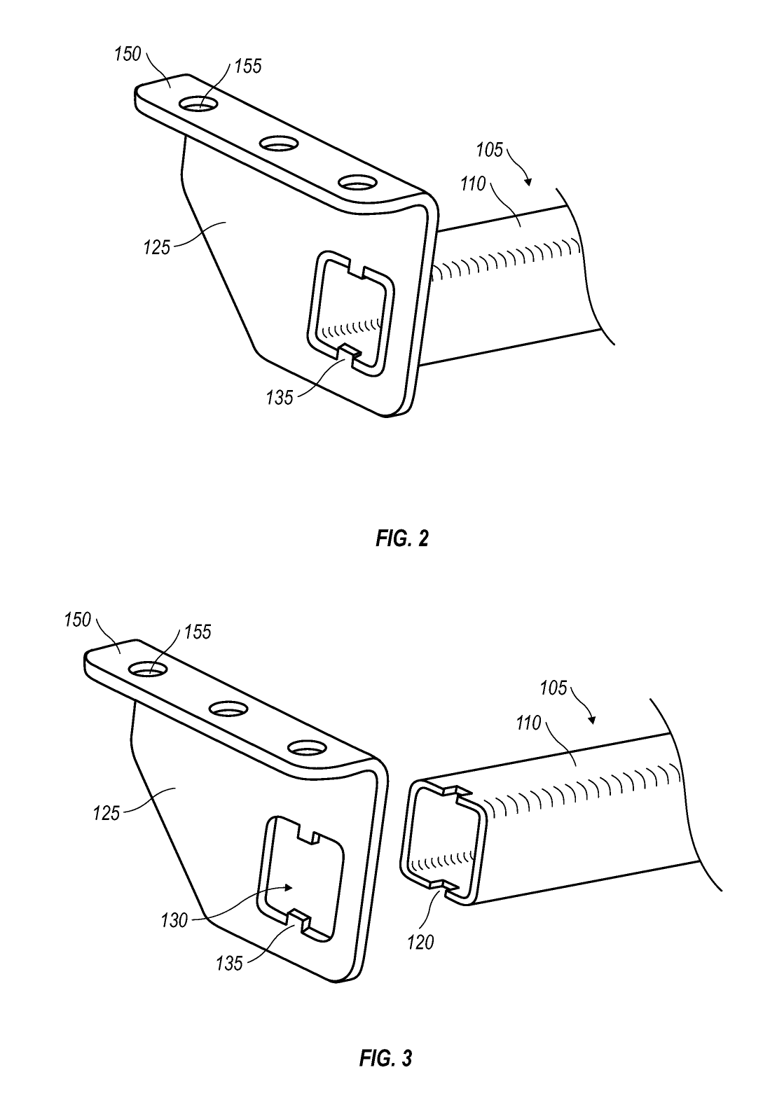

In alternative embodiments, a plurality of notches 120 can be disposed on one of the first distal end 110 and second distal end 115 of the cross-member. FIG. 1 illustrates a plurality of notches 120 disposed on each of the distal ends 110, 115 of the cross-member 105. In FIG. 1, both the first distal end 110 and the second distal end 115 each have two notches 120 disposed on the distal end. While the notches of the plurality of notches 120 illustrated in FIG. 1 have the same shape, the plurality of notches 120 can have different shapes from each other. A fixed orientation of the cross-member 105 with the mounting member 125 can result from using a plurality of notches 120 that have different shapes from each other. FIG. 1 also illustrates the plurality of notches 120 disposed opposite each other on a distal end 110, 115 of the cross-member 105. In an alternative embodiment, the plurality of notches 120 can be disposed adjacent each other on the distal end 110, 115 of the cross-member 105. While the illustrated embodiment of FIG. 2 shows only two notches 120 on each distal end 110, 115 of the cross-member, other embodiments may include three or more notches on one of the first distal end 110 and the second distal end 115 to ensure a suitable orientation and alignment of the cross-member 105 with the mounting member 125.

The illustrated embodiment of the cross-member assembly 100 in FIG. 1 includes two mounting members 125. The mounting member 125 can be a mounting bracket, a mounting plate, or other similar element to mount the cross-member assembly 100 to the frame of a vehicle. The mounting member 125 can include an aperture 130 configured to receive one of the first distal end 110 and the second distal end 115 of the cross-member 105 when the cross-member assembly 100 is assembled. Accordingly, the aperture 130 has a shape that corresponds to the shape of the cross-section of the cross-member 105. As illustrated in FIG. 1, the aperture 130 has a square shape to correspond to the square cross-section of the cross-member 105. In alternative embodiments, the aperture 130 can have a circular shape, a diamond-shape, a rectangular shape, or other similar shape that corresponds to the cross-section of a cross-member 105.

One of ordinary skill in the art will appreciate that although the cross-member 105 is configured substantially straight and horizontally between the mounting members 125 in FIG. 1, the cross-member 105 can be coupled to the mounting members 125 in any configuration. For example, the cross-member 105 can be coupled between the mounting members 125 such that an incline is formed.

Still referring to FIG. 1, at least one protuberance 135 can be formed on the aperture 130. While FIG. 1 illustrates at least one protuberance 135 that is a self-locating tab, one of ordinary skill in that art will appreciate that the at least one protuberance 135 can be an ear, a projection, a boss, a protrusion, a lobe or other similar protuberance. In alternative embodiments, the at least one protuberance 135 can have a square shape, a rounded shape, a rectangular shape, a triangular shape, or other similar shape. The at least one protuberance 135 is formed on the aperture 130 such that when a distal end 110, 115 of the cross-member 105 is received by the aperture 130, the at least one notch 120 of the cross-member 105 is aligned and matingly engaged with the at least one protuberance 135 of the mounting member 125.

In FIG. 1, a plurality of protuberances 135 are shown, and each protuberance 135 is oppositely disposed from the other. In alternative embodiments, the protuberances 135 can be disposed adjacent to each other. FIG. 1 illustrates protuberances 135 having a square shape. While the FIG. 1 illustrates protuberances 135 that are substantially similar in shape, in alternative embodiments, the protuberances 135 can have different shapes from each other. In at least one embodiment, the mounting member 125 can have two protuberances 135 (shown in FIG. 1), but in alternative embodiments, the mounting member 125 can have three protuberances 135, four protuberances, or more. Additionally, if more than one mounting member 125 has protuberances 135, each mounting member 125 can have a number of protuberances 125 that is different from the other mounting member 125. For example, one mounting member 125 can have one protuberance 135 and the other mounting member 125 can have three protuberances 135.

The mounting member 125 can also include a lip 150 formed at an edge of the mounting member 125. The lip 150 is configured to abut the frame of a vehicle and to mount the cross-member assembly 100 to the vehicle. In FIG. 1, the lip 150 is an L-shaped bend formed at a top portion of the mounting member 125. In alternative embodiments, the lip 150 can be an additional plate that is mounted or welded to the mounting member 125. As illustrated in FIG. 1, the lip 150 can, but does not need to, include a plurality of mounting apertures 155. The mounting apertures 155 can be configured for bolting the cross-member assembly 100 to the vehicle. While the lip 150 as illustrates is substantially flat, in other embodiment, the lip 150 is shaped to conform to the portion of the frame for which it is attached. In yet other embodiments, no lip may be included as the mounting member 125 can be secured directly to the frame. In further alternative embodiments, the mounting member 125 can be mounted to the frame by being integrated with the vehicle frame, welded to the vehicle frame, adhesively bonded to the vehicle frame, or mounted to the frame by any other suitable configuration.

FIGS. 2 and 3 are partial views of the hitch cross-member assembly as illustrated in FIG. 1 in an assembled and a disassembled configuration, respectively. As illustrated in FIG. 2, the at least one notch 120 is engaged with the at least one protuberance 135. As a result of the mating engagement between the notches 120 and the protuberances 135, the cross-member 105 and the mounting member 125 are aligned or joined, and a final weld can be made to assemble the components of the cross-member assembly 100. In FIG. 2, an end surface of the first distal end 110 of the cross-member 105 is flush with a surface of the mounting member 125. FIG. 3 illustrates the mounting member 125 disassembled from the first distal end 110 of the cross-member 105. At least one notch 120 is disposed on the first distal end 110 and has a rectangular shape, which corresponds to the rectangular-shaped protuberances 135 of the mounting member 125. Also in FIG. 3, at least one notch 120 is disposed on the first distal end 110 to correspond to the location of the protuberances 135 formed on the aperture 130 of the mounting member 125. When the distal end 110 of the cross-member 105 is inserted into or received by the aperture 130 of the mounting member 125, the cross-member 105 is aligned with the mounting member 125, and the at least one protuberance 135 and at least one notch 120 are matingly engaged to align the components of the cross-member assembly 100 together. With the cross-member 105 and the mounting member 125 aligned, a final weld can be made to secure the cross-member assembly 100. Since the at least one protuberance 135 fits in the at least one notch 120 of the cross-member 105, the outside edge of the distal end 110 of the cross-member 105 becomes flush with the outside-facing surface of the mounting member 125, as illustrated in FIG. 2. FIGS. 2 and 3 also illustrate a lip 150 formed at the top edge of the mounting member 125. The lip 150 includes a plurality of mounting apertures 155 configured to mount the cross-member assembly 100 to the frame of a vehicle. While the illustrated embodiment shows three mounting apertures 155, the mounting member 125 can have one mounting aperture 155, two mounting apertures 155, no mounting apertures 155, more than three mounting apertures 155, or any number of mounting apertures 155.

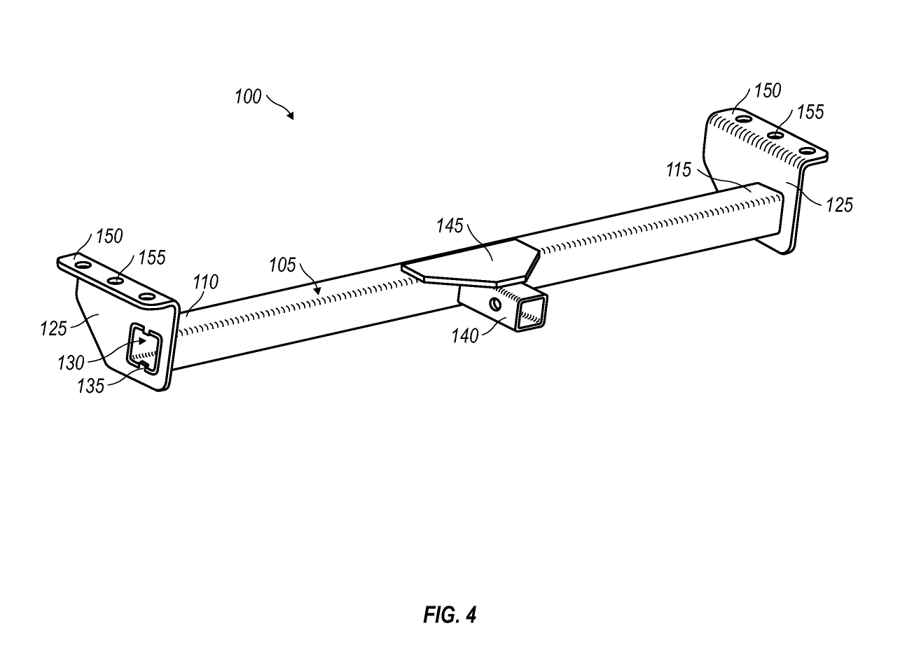

FIG. 4 is a front plan view of the exemplary cross-member assembly 100 as illustrated in FIG. 1 in an assembled configuration. FIG. 4 illustrates each of the first distal end 110 and the second distal end 115 of the cross-member is received by a mounting member 125. When the distal ends 110, 115 are aligned with the mounting members 125, a final weld can be made to secure the cross-member 105 to the mounting members 125. Since the notches 120 of the cross-member 105 and the protuberances 135 of the mounting member 125 matingly engage, tack welds are not necessary to ensure and maintain proper alignment of the cross-member 105 and the mounting members 125. Thus, the towing cross-member hitch assembly 100 in accordance with the exemplary embodiments described herein provides for a less-cumbersome assembly of a towing hitch.

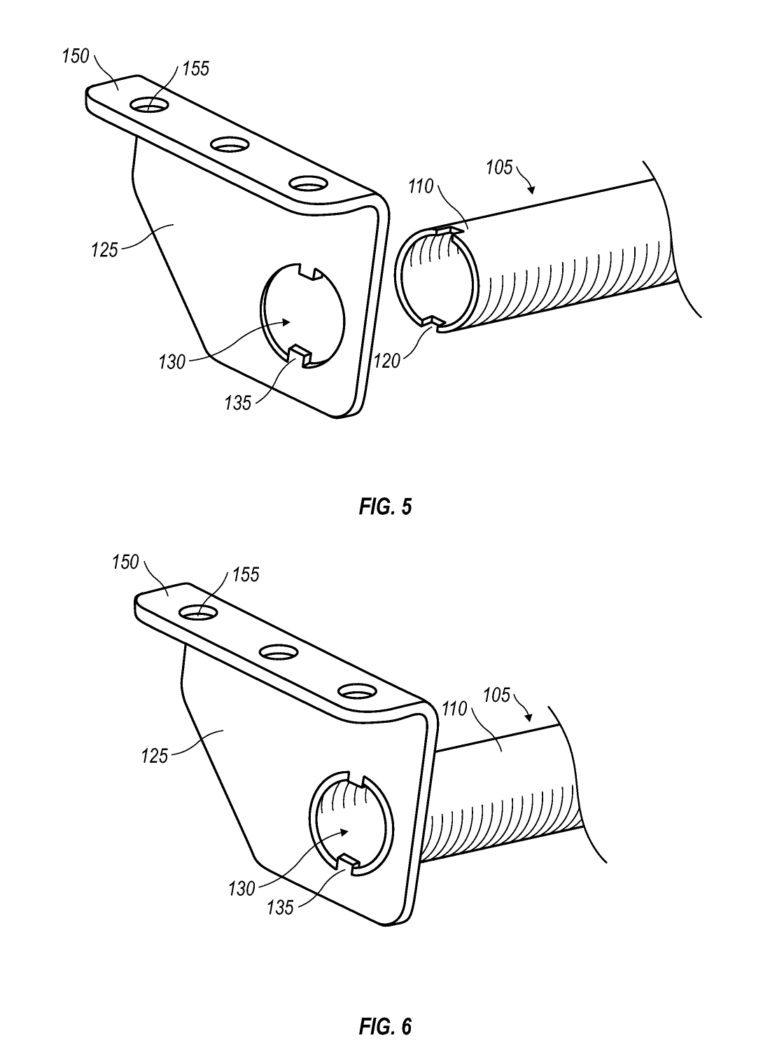

FIGS. 5 and 6 are partial views of the hitch cross-member assembly 100 in an assembled and disassembled configuration, respectively. The embodiment illustrated in FIGS. 5 and 6 includes a distal end 110 of a cross-member 105 having a circular cross-section having at least one square-shaped notches 120 disposed on the distal end 110 of the cross-member 105. The mounting member 125 has a circular aperture 130 configured to receive the distal end 110 of the cross-member 105 having a circular cross-section. At least one protuberance 135 is formed on the aperture 130 and is configured for mating engagement with the at least one notch 120 on the distal end 110 of the cross-member 105. The at least one notch 120 is disposed on the distal end 110 to correspond with the locations of the protuberances 135 on the mounting member 125. In FIGS. 5 and 6, each notch 120 is oppositely disposed from the other. However in alternative embodiments, the notches 120 can be disposed adjacent to each other. Correspondingly, each protuberance 135 can be formed opposite each other or can be formed adjacent to each other. The protuberances 135 and the notches 120 are configured to matingly engage with each other when the distal end 110 is received by the aperture 130 of the mounting member 125. FIG. 6 illustrates the notches 120 engaged with the protuberances 135. As a result of the mating engagement between the notches 120 and the protuberances 135, the cross-member 105 and the mounting member 125 are aligned and temporarily connected. In FIG. 6, a surface of the first distal end 110 of the cross-member 105 is flush with a surface of the mounting member 125. When the distal end 110 of the cross-member 105 is inserted into or received by the aperture 130 of the mounting member 125, the distal end 110 of the cross-member 105 is aligned with the mounting member 125, and the protuberances 135 and notches 120 are matingly engaged to align the components of the cross-member assembly 100. Since the protuberances 135 fit within the notches 120 of the cross-member 105, the outside edge of the distal end 110 of the cross-member becomes flush with the outside-facing surface of the mounting member 125 as shown in FIG. 6. FIGS. 5 and 6 also illustrate a lip 150 at the top edge of the mounting member 125. The lip 150 includes a plurality of mounting apertures 155 configured to mount the cross-member assembly 100 to the frame of a vehicle. While the illustrated embodiment shows three mounting apertures 155, the mounting member 125 can have one mounting aperture 155.

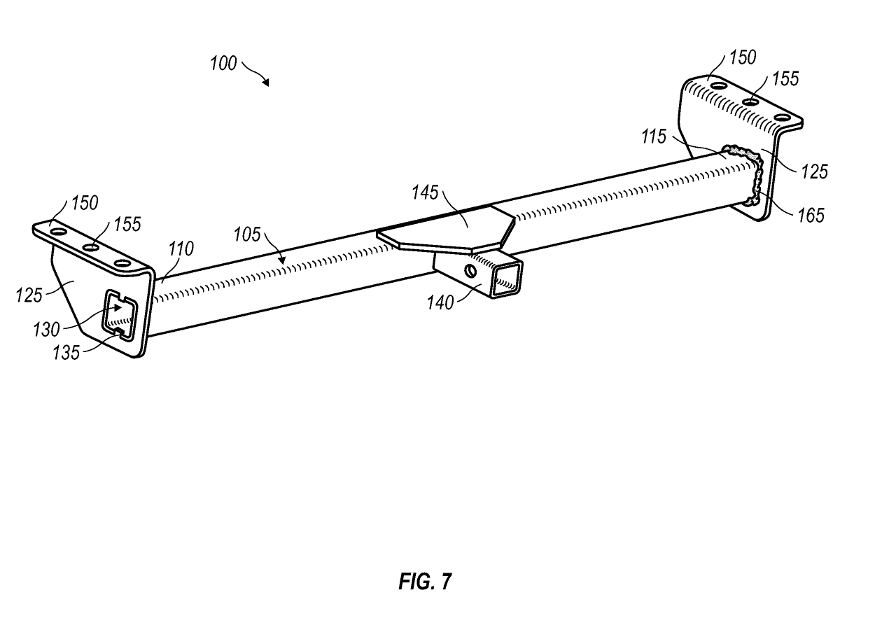

FIG. 7 is a front plan view of an assembled hitch cross-member assembly 100 in accordance with an exemplary embodiment illustrated in FIG. 1 having a welded coupling. In an assembled configuration, each of the first distal end 110 and the second distal end 15 is received by the mounting member 125. Where the distal ends 110, 115 join the mounting member 125, a welded coupling permanently secures the mounting member 125 to the cross-member 105. In an alternative embodiment, the coupling 165 can be an adhesive coupling, a brazed coupling, a bonding compound coupling a combination of an adhesive coupling and a welded coupling, or other similar couplings that can permanently secure the mounting member 125 to the cross-member 105 or that can secure the mounting member 125 to the cross-member 105 to allow the cross-member assembly 100 to handle a load from a trailer, according to the desired hitch class.

FIGS. 7-9 illustrate a cross-member assembly 100 with self-locating tabs having a receiver 140. In each embodiment, the receiver 140 is disposed on the cross-member 105 between the first distal end 110 and the second distal end 115 and disposed substantially perpendicular to the cross-member 105. In the exemplary embodiments illustrated in FIGS. 7-9, the receiver 140 is perpendicularly coupled to the cross-member 105 at the center of the cross-member 105. However, in alternative embodiments, the receiver 140 can be coupled at other locations between the first distal end 110 and the second distal end 115 of the cross-member 105. One of ordinary skill in the art will appreciate that the receiver 140 can be coupled anywhere along the cross-member 105 such that a trailer can be attached to the receiver 140 when the cross-member assembly 100 is mounted to a vehicle. Returning to FIGS. 7-9, the receiver 140 is a hollow tube having a square cross-section. In alternative embodiments, the receiver 140 can be a tongue, a tube having a circular cross-section, or other element on which a trailer can be attached.

The receiver 140 can also be coupled to the cross-member in various manners. FIG. 7 illustrates the receiver 140 coupled to the cross-member 105 by a mounting plate 145. In such an embodiment, the receiver 140 can be welded to mounting plate 145, and the mounting plate 145 can be mounted and welded to the cross-member 105. In an alternative embodiment, the receiver 140 can be welded to both the mounting plate 145 and the cross-member 105, and the mounting plate 145 can provide further strength and stability for the receiver 140 as it bears a load from an attached trailer. In other alternative embodiments, the receiver 140 can be adhesively coupled or bonded to the cross-member 105 and to the mounting plate 145, and the mounting plate 145 can be welded to the cross-member 105 to ensure a permanent coupling with the cross-member 105 or a coupling that will allow the cross-member assembly 100 to withstand the load from a trailer. Regardless of the combinations of couplings between the mounting plate 145, the receiver 140, and the cross-member 105, the receiver 140 is coupled to the cross-member 105 such that the cross-member assembly 100 can handle a load exerted by pulling an attached trailer. For example, the receiver 140 is coupled to the cross-member 105 such that the cross-member assembly can handle up to 1000 pounds, up to 2000 pounds, up to 3000 pounds, or more, depending on the type of hitch assembly required (such as a Class I or Class II hitch). In other embodiments, the type of hitch can be another Class of hitch as required.

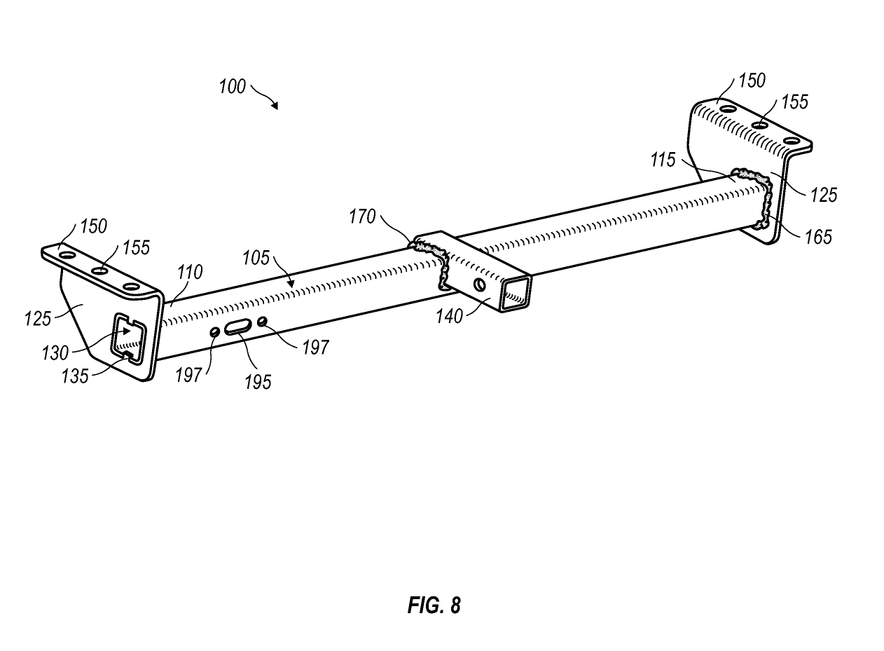

FIG. 8 illustrates an alternative embodiment of a cross-member assembly 100 in accordance with the present disclosure having self-locating tabs, where the receiver 140 is integrated with the cross-member 105. In the exemplary embodiment of FIG. 8, a slot is cut out of the cross-member 105, and the slot is configured to receive a receiver 140. The slot can have a square shape to accommodate the rectangular-shaped receiver 140. However, in alternative embodiments, the slot can be any shape that accommodates the shape of the receiver 140. The receiver 140 can be secured within the slot by a welded coupling 170, an adhesive coupling, a combination of both an adhesive coupling and a welded coupling, or any other coupling that will allow the cross-member assembly 100 to withstand the load from an attached trailer. In an alternative embodiment, the receiver 140 can be integrated with the cross-member 105 by being formed from the cross-member 105. For example, the cross-member 105 can be cast into a T-shape, where the perpendicular center portion of the “T” is the receiver 140. In such embodiments where the receiver 140 is formed from the cross-member 105, the cross-member 105 and the receiver 140 are formed as a single component.

Also illustrated in FIG. 8, the cross-member assembly 100 can include an electrical connection aperture 195. The electrical connection aperture 195 can be adapted to receive electrical wires and components for electrically coupling a vehicle to which the cross-member assembly 100 is attached and an object to be towed by the vehicle. For example, in at least one implementation, the electrical component (not shown) can include an electrical connector for the lights of the vehicle to corresponding lights on the object being towed. Additionally, the electrical connector can provide for braking power and reverse signals. Additionally, the electrical connection aperture 195 can be adapted to receive any other electrical component. An attachment point 197 is provided on either side of the electrical connection aperture 195. In one embodiment, an electronic component can be inserted in the electrical connection aperture 195 and can be mounted or attached to the cross-member 105 using the attachment points 197. For example, the electrical component can be mounted to the cross-member 105 by inserting a screw or a bolt through the attachment point 197. However, in other implementations, the electrical component can be mounted to the cross-member 105 at the attachment points 197 by any other attachment means that secures an electrical component to the cross-member. While the illustrated embodiment shows an ovular-shaped electrical connection aperture 195 to the left of the receiver 140, one of ordinary skill in the art will appreciate that the electrical connection aperture 195 can have any other shape that can receive electrical wires and components. Additionally, it will be appreciated that the electrical connection aperture 195 can be placed anywhere on the cross-member 105 that allows for the electrical coupling between a vehicle and the object to be towed by the vehicle. While two attachment points 197 have been illustrated in FIG. 8, one of ordinary skill in the art will appreciate that fewer or more than attachment points 197 can be utilized than as illustrated. In another embodiment, two attachment points 197 can be provided to the left of the electrical connection aperture 195 and one attachment point 197 can be provided to the right of the electrical connection aperture 195. However, any combination and arrangement of attachment points 197 can be implemented so long as an electrical connector can be securely coupled or attached to the cross-member assembly 100. Those of skill in the art will also appreciate that while the electrical connection aperture 195 and attachment points 197 are provided on the cross-member assembly 100 illustrated FIG. 8, the electrical connection aperture 195 and attachment points 197 can be provided on any of the cross-member assemblies 100 illustrated herein and can be combined with any other components described herein to achieve the technical advantages of the present technology.

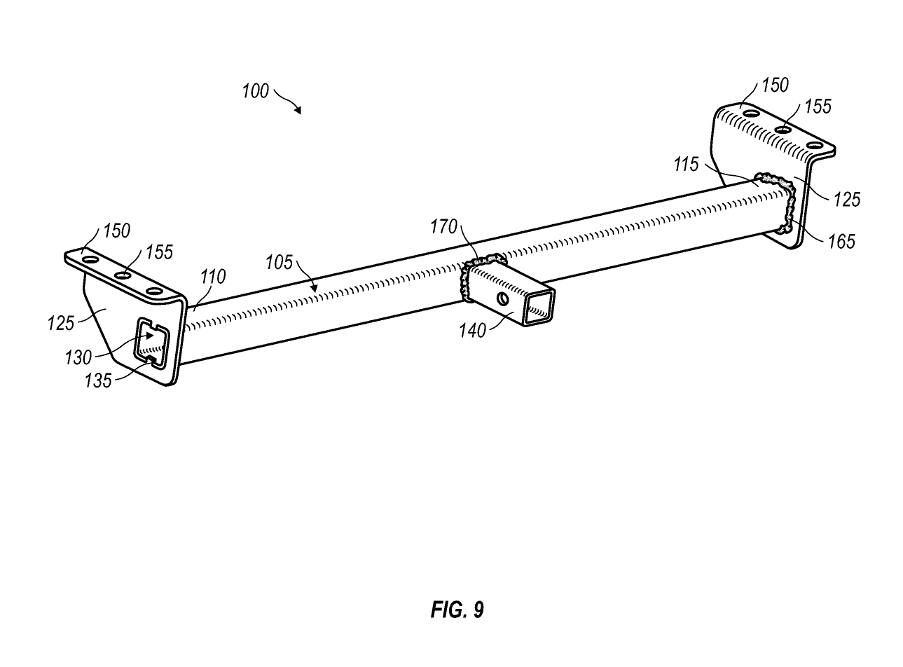

FIG. 9 illustrates an alternative embodiment of a cross-member assembly 100 in accordance with the present disclosure having self-locating tabs, where the receiver 140 is welded to the cross-member 105. In the exemplary embodiment of FIG. 9, the receiver 140 is welded 170 to the cross-member 105 without a mounting plate. Although FIG. 9 illustrates the receiver 140 welded at the center of the cross-member 105 between the first distal end 110 and the second distal end 115, one of ordinary skill in the art will appreciate that the receiver 140 can be welded anywhere along the cross-member 105 such that a trailer can be attached to the receiver 140 when the cross-member assembly 100 is mounted to a vehicle. In an alternative embodiment, the receiver 140 can be adhesively coupled to the cross-member or can be coupled by any other process that permits the cross-member assembly 100 to handle a load exerted by pulling an attached trailer. For example, the receiver 140 is coupled to the cross-member 105 such that the cross-member assembly 100 can handle the desired hitch load.

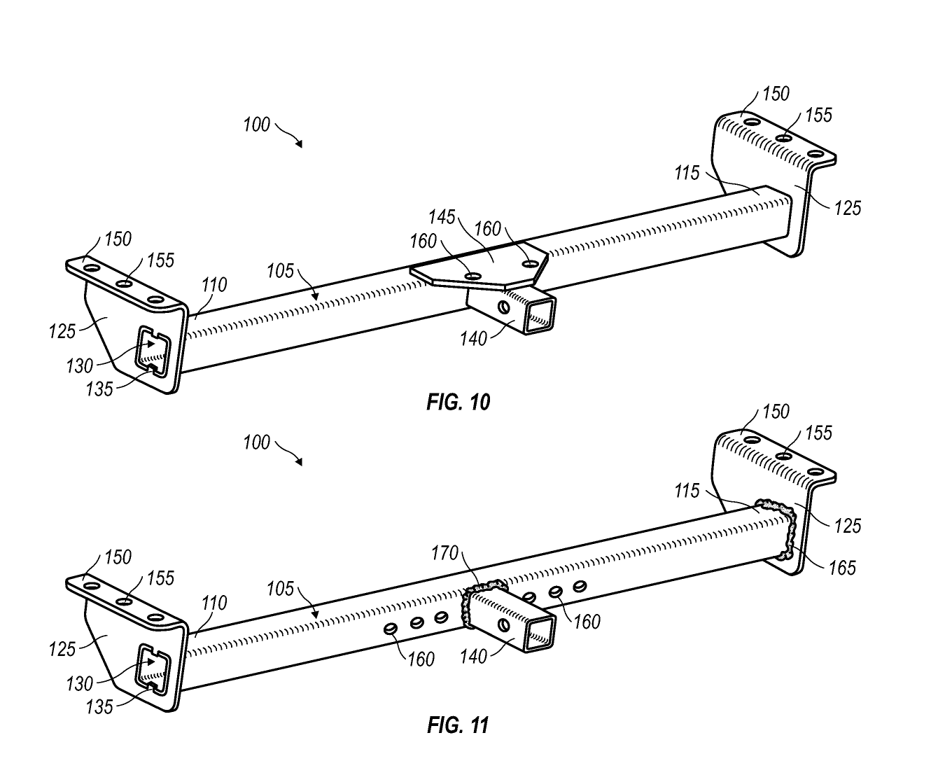

FIGS. 10-11 are front plan views of alternative embodiments of a cross-member assembly 100 having self-locating tabs, where the cross-member assembly 100 includes safety apertures 160. Safety apertures 160 are configured to receive attachment elements of safety chains for trailers. For example, to ensure a trailer is securely attached to the receiver 140 of a hitch cross-member assembly 100, chains can be hooked to the safety aperture 160 as a safety precaution should the receiver 140 and the trailer attachment become detached. In the exemplary embodiment illustrated in FIG. 10, the safety apertures 160 are disposed on the mounting plate 145. In an alternative embodiment, the safety apertures 160 can be disposed on the cross-member 105 as illustrated in FIG. 11. With such an embodiment, the safety apertures 160 can be disposed anywhere along the cross-member 105 such that safety chains from a trailer can be attached or hooked on to the safety apertures 160. For example, in FIG. 11, a plurality of safety apertures 160 is disposed on the cross-member 105 on either side of the receiver 140. While a plurality of safety apertures 160 are illustrated in FIGS. 10 and 11, one of ordinary skill in the art will appreciate that the cross-member assembly 100 can include one safety aperture 160.

While the following method is described with respect to the exemplary towing hitch cross-member assembly 100 illustrated in FIG. 1, other components as described above can be included in the method and constructed as appropriate. The method of constructing the towing hitch cross-member assembly 100 having self-locating tabs can include providing a tube and at least one plate. The tube can be constructed to form the cross-member 105, and the at least one plate can be constructed to form the at least one mounting member 125. The method can also include: cutting an aperture 130 through the at least one plate such that at least one protuberance 135 is formed on the aperture 130; and cutting at least one notch 120 at a first distal end 110 of the steel tube, wherein the at least one notch 120 is configured to matingly engage with the at least one protuberance 135. The at least one plate can be a flat plate or a plate having a thickness. As the plate can be constructed to form the mounting member 125 which attaches the towing hitch cross-member assembly 100 to a vehicle, the plate will have at least a minimum thickness to ensure the cross-member assembly 100 remains attached to the vehicle when a trailer is attached to and exerts a load on the assembly 100. The tube can have any cross-sectional shape such that an aperture 130 can be cut through the plate to correspond to the cross-sectional shape of the tube. While the embodiment illustrated in FIG. 1 is a steel tube, one of ordinary skill in the art will appreciate that the tube can be made of any other durable material that can withstand the load exerted by a trailer when the trailer is attached to the cross-member assembly 100. In alternative embodiments, the tube can be an aluminum tube or other durable material.

An aperture 130 is cut out of the plate to correspond with the cross-sectional shape of the tube. With the exemplary embodiment illustrated in FIG. 1, a square aperture 130 is cut out of the plate to correspond with the square cross-section of the distal end 110, 115 of the tube. However, one of ordinary skill in the art will appreciate that the aperture 130 can be any shape such that it corresponds to the shape of the distal end 110, 115 of the tube so that the aperture 130 can receive the distal end 110, 115 of the tube. The protuberances 135 and the notches 120 are formed and cut, respectively, to correspond to each other. As illustrated in FIG. 1, square shaped protuberances 135 are formed on the aperture 130 of the at least one plate to correspond to the square notches 120 cut out of the distal ends 110, 115 of the tube. As FIG. 1 illustrates a cross-member assembly 100 having two mounting members 125, two plates can be cut to have apertures 130 with at least one protuberance 135 formed on the aperture 130. Accordingly, the two distal ends 110, 115 of the tube can be cut to include at least one notch 120 on each of the distal ends 110, 115.

Regarding the notches 120 of the tube, the notches 120 are cut to a depth corresponding to the thickness of the plate. For example, as illustrated in FIGS. 1 and 2, the notches 120 are cut into the distal end 110 of the tube to a depth that allows the outside surface of the distal end 110 to be flush with the outside-facing surface of the plate or the mounting member 125. The notches 120 are also cut to receive and matingly engage with the protuberances 135 of the plate. While the embodiment illustrated in FIGS. 1 and 2 show square shaped notches 120 and protuberances 135, one of ordinary skill in the art will appreciate that the notches 120 and protuberances 135 can be any shape that permits mating engagement between the notches 120 and protuberances 135, and permit the engagement of the tube and plate such that the outside surface of the distal end 110 of the tube is flush with the outside-facing surface of the plate, when the cross-member assembly 100 is assembled.

In an exemplary embodiment of the method for constructing a towing hitch cross-member assembly comprising a tube and at least one plate, cutting the aperture 130 through the at least one plate and cutting at least one notch 120 at a distal end 110, 115 of the tube can be accomplished by a laser cutting process. In alternative embodiments, the cutting can be accomplished by a milling technique, a laser machining process, or any other similar precision machining or precision cutting process. Using a precision machining or precision cutting process can ensure accurately sized cuts and can maintain the material strength of the plate and the tube after the plate and tube are cut.

The method for constructing a towing hitch cross-member assembly 100 comprising a tube and at least one plate can also include aligning the first distal end 110 of the tube with the aperture 130 of the at least one plate such that the at least one protuberance 135 and the at least one notch 120 are matingly engaged, as illustrated by FIGS. 2 and 3. For example, the distal end 110 of the tube is received by the aperture 130 of the at least one plate. When the distal end 110 is received by the aperture 130, the protuberances 135 engage and are received by the notches 120 of the tube. The distal end 110 continues to be received by the aperture 130 until the inside surface of the protuberances 135 abuts the outside surface of the notches 120 and until the outside surface of the distal end 110 of the tube is flush with the outside-facing surface of the at least one plate, as illustrated by FIG. 2.

The method for constructing a towing hitch cross-member assembly 100 comprising a tube and at least one plate can also include securing a coupling between the tube and the at least one plate. In one embodiment, securing a coupling between the tube and the at least one plate comprises welding the tube to the at least one plate at a location where a surface of the distal end 110, 115 is flush with the at least one plate. For example, in the embodiment illustrated in FIG. 7, a welded coupling 165 is made between the tube and the at least one plate where the top surface of the second distal end 115 is flush with a surface of the aperture 135 of the at least one plate. A similar coupling can be made between the tube and the at least one plate where the top surface of the first distal end 110 is flush with a surface of the aperture 135 of the at least one plate. While FIG. 7 illustrates securing a coupling by welding, one of ordinary skill in the art will appreciate that securing a coupling can also include adhesively coupling the tube and the at least one plate, bonding the tube and the at least one plate, a combination of both welding and adhesively coupling the tube and the at least one plate, or any other coupling that permits the cross-member assembly 100 to remain mounted to a vehicle when a load is exerted by a trailer attached to receiver member 140 of the cross-member assembly 100.

The method for constructing a towing hitch cross-member assembly 100 comprising a tube and at least one plate can also include coupling a receiver member 140 perpendicularly to the tube between the first distal end 110 and the second distal end 115 of the tube. FIGS. 7-9 illustrate exemplary embodiments of coupling a receiver member 140 perpendicularly to the tube between the first distal end 110 and the second distal end 115 of the tube. FIG. 7 illustrates coupling a receiver member 140 perpendicularly to the tube by mounting the receiver member 140 with a receiver plate or a mounting plate 145. The mounting plate 145 can be welded to the tube, adhesively coupled to the tube, both adhesively coupled and welded to the tube, or otherwise coupled to the tube to ensure the cross-member assembly 100 can withstand a load exerted by a trailer attached to the receiver member 140.

FIG. 8 illustrates coupling a receiver member perpendicularly to the tube by integrating the receiver member 140 with the tube. Integrating the receiver 140 with tube can comprise cutting a slot in a center portion of the tube such that the slot is perpendicular to the longitudinal axis of the tube and wherein the slot is shaped to receive the receiver member 140. A receiver member 140 can be aligned in the slot, and a coupling can be secured between the tube and the receiver member 140. For example, the receiver member 140 can be coupled in the slot by a welded coupling, an adhesive coupling, a bonding coupling, a combination of a welded and an adhesive coupling, or any other suitable coupling that permits the cross-member assembly 100 to withstand a load exerted by a trailer attached to receiver member 140 of the cross-member assembly 100. In an alternative embodiment, integrating the receiver member 140 with the tube can comprise forming the receiver member 140 from the tube. For example, the tube can have a T-shape, and the receiver member 140 can be the perpendicular portion of the “T.”

FIG. 9 illustrates coupling a receiver member 140 to the tube by welding the receiver member 140 perpendicularly to the tube. As illustrated in FIG. 9, a weld 170 is made where the receiver member 140 is flush with the outer surface of the tube. In an alternative embodiment, coupling the receiver member 140 can also include adhesively bonding the receiver member 140 to the tube, bonding the receiver member 140 to the tube, a combination of adhesively bonding and welding the receiver member 140 to the tube, or any other coupling that permits the cross-member assembly 100 to withstand a load exerted by a trailer attached to receiver member 140 of the cross-member assembly 100.

The method for constructing a towing hitch cross-member assembly 100 comprising a tube and at least one plate can also include forming at least one safety aperture 160 to the cross-member assembly 100. FIGS. 10 and 11 illustrate exemplary embodiments of forming at least one safety aperture 160 to the cross-member assembly 100. FIG. 10 illustrates cutting at least one safety aperture 160 on the receiver plate or the mounting plate 145 for the receiver 140. The at least one safety aperture 160 can be cut by laser cutting, milling, laser machining, or any other similar precision cutting or precision machining. While the safety aperture 160 can be cut into the receiver plate or mounting plate 145, in alternative embodiments, the safety apertures 160 can be pre-cut into a mounting plate 145 configured to be coupled to the tube and to the receiver 140. In either embodiment of the method including forming at least one safety aperture 160 on the cross-member assembly 100, one of ordinary skill in the art will also appreciate that the safety apertures 160 can be cut out of the receiver plate or the perimeter of the tube by laser cutting, milling, laser machining, or any other similar precision cutting or precision machining. In either embodiment, the at least one safety aperture 160 is disposed at a location where attachment elements of safety chains for trailers can be coupled to the cross-member assembly 100. For example, to ensure a trailer is securely attached to the receiver 140 of a hitch cross-member assembly 100, chains can be hooked onto the safety aperture 160.

As illustrated in FIG. 11, forming at least one safety aperture 160 on the cross-member assembly 100 can comprise cutting at least one safety aperture on a perimeter of the tube, wherein the safety aperture 160 is located in between the first distal end 110 and the second distal end 115 of the tube. In FIG. 11, the at least one safety aperture 160 is cut out of the perimeter of the tube on either side of a receiver 140. In alternative embodiments, safety apertures 160 can be cut out anywhere along tube such that safety chains from a trailer can be attached or hooked to the safety apertures 160. While a plurality of safety apertures 160 are illustrated in FIGS. 10 and 11, one of ordinary skill in the art will appreciate that the cross-member assembly 100 can include one safety aperture 160. In either embodiment of the method including forming at least one safety aperture 160 on the cross-member assembly 100, one of ordinary skill in the art will also appreciate that the safety apertures 160 can be cut out of the receiver plate or the perimeter of the tube by laser cutting, milling, laser machining, or any other similar precision cutting or precision machining.

The method for constructing a towing hitch cross-member assembly 100 comprising a tube and at least one plate can also include forming a lip on an edge of the at least one plate, as illustrated in at least FIGS. 2, 3, 5, and 6. As shown in the illustrated embodiments, a lip 150 is formed at a top edge of the at least one plate. The lip 150 can be formed by heating the plate and then bending the plate such that the lip 150 perpendicular to the rest of the plate. One of ordinary skill in the art will appreciate that other methods of bending or forming a plate can be used to form the lip on an edge of the plate 150. As a result of including a lip 150 on the plate, the plate forms a mounting member 125 or a mounting bracket configured to mount the cross-member assembly to a vehicle. While the illustrated embodiments, show a lip 150 formed perpendicularly to the rest of the mounting member 125, one of ordinary skill in the art will appreciate that the lip 150 can form any angle with the rest of the plate or mounting member 125 that permits the cross-member assembly 100 to mount to a vehicle. In another alternative embodiment, at least one mounting aperture 155 can be cut out of the lip 150 as illustrated in at least FIGS. 2, 3, 5, and 6. The mounting aperture 155 can be cut out of the at least one plate by laser cutting, milling, laser machining, or any other similar precision cutting or precision machining.

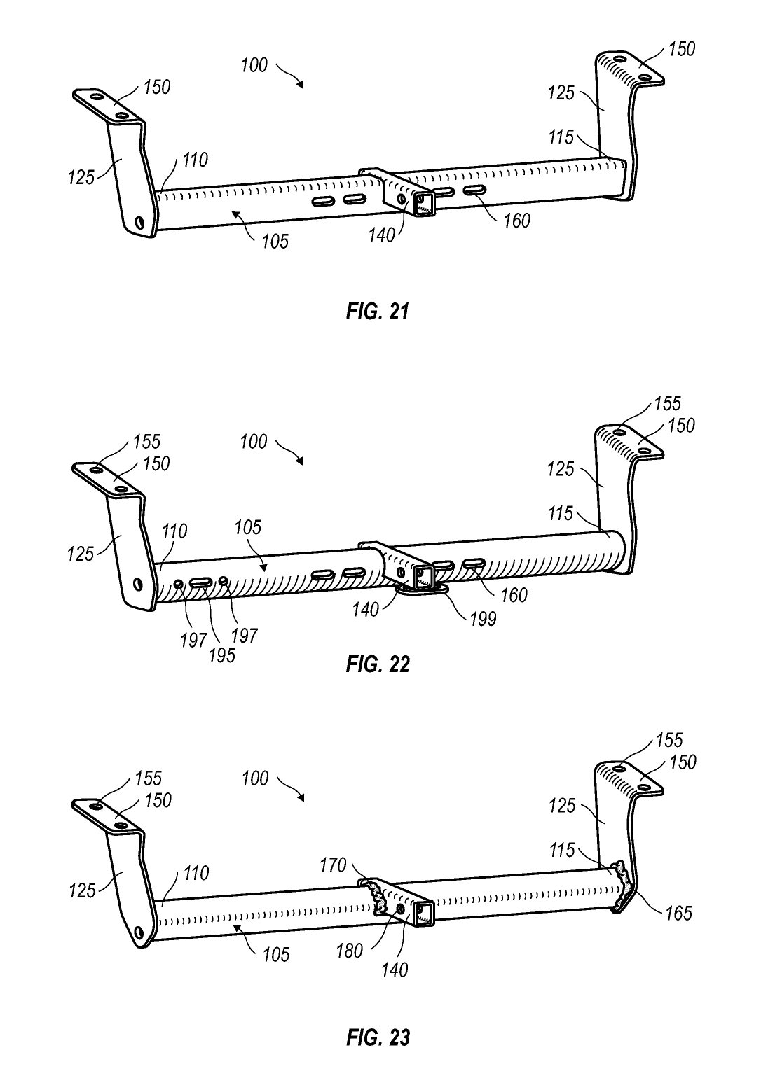

FIGS. 12-25 describe alternative embodiments of the hitch cross-member assembly, where the cross-member 105 is a slotted cross member. FIG. 12 is a front perspective view of a towing hitch assembly 100 in accordance with an exemplary embodiment having a slotted cross-member 105 in a disassembled configuration. The towing hitch assembly 100 can include an elongate cross-member 105 configured to be mounted to a vehicle having a slot 190 configured to receive a receiver 140. Similar to the cross-member illustrated in FIGS. 1, 4, and 7-11, the cross-member 105 can have a first distal end 110 and a second distal end 115. As illustrated, the cross-member 105 is a square tube turned at an angle relative to one of the sides such that in a mounted configuration, it has a cross-section that is a diamond cross-section. In alternative embodiments, the cross-member 105 can have a square cross-section (shown in FIG. 21), a circular cross-section (shown in FIG. 22), a rectangular cross-section, or other similar cross-sections.

The cross-member 105 illustrated in FIG. 12 differs from that illustrated in FIGS. 1, 4, and 7-11 in that the cross-member 105 comprises a slot 190 disposed in between the first distal end 110 and the second distal end 115. The slot 190 can be disposed substantially perpendicularly to a longitudinal axis 200 of the cross-member 105 and can be configured to receive the receiver 140. The particular embodiment illustrated in FIG. 12 shows a slot 120 formed on the top surface of the cross-member 105 and configured to receive a square-shaped receiver 125. In FIG. 12, the receiver 140 is a square hollow tube having a pin aperture 150 configured to receive a pin, nut and bolt, or other element that secures a trailer to the towing hitch assembly 100. Additionally, the receiver 140 can be configured to be inserted into the slot 190 of the cross-member 105. In alternative embodiments, the receiver 140 can be a flat tongue, a flat plate, a diamond-shaped tube, a rectangular tube, a beam, a circular tube, or other similar receiving element for attaching a trailer to the hitch assembly 100. In either embodiment, the slot 190 and the receiver 140 are configured and shaped to correspond to each other thereby allowing proper alignment and a suitable coupling for a final weld between the receiver 140 and cross-member when the towing hitch assembly 100 is assembled. While the illustrated slot 190 in FIG. 12 is shaped to receive a receiver 140 that is a square hollow tube, one of ordinary skill in the art will appreciate that the slot 190 can have a shape to receive a rounded, rectangular, ovular, or any other shape a receiver 140 configured to be inserted in the slot 190. As the slot 190 and receiver 140 are configured to allow proper alignment and a suitable coupling for a final weld, preliminary tack welds and temporary fasteners are unnecessary to make a final weld of the towing hitch assembly 100. Additionally, the area comprising the receiver 140 is accessible for cleaner and better welding. As the slot 190 shaped in the cross-member 105 to accommodate the receiver 140, a more suitable weld can be made. For example, a round receiver can be welded to a slotted cross-member having a square cross-section with less difficulty, because of the corresponding shapes of the slot 190 and receiver 140. The strength of the towing hitch assembly 100 is also enhanced because the receiver 140 is embedded into the cross-member 105. As the receiver 140 is integrated or embedded into the cross-member 105, fewer parts or components are required to construct the towing hitch assembly 100. For example, instead of joining two cross-members to a receiver to construct the towing hitch assembly 100, one cross-member 105 can be used and a slot 190 can be cut into the cross-member 105 to receive the receiver 140. Additionally, the weight of the towing hitch assembly 100 can be reduced since fewer components are required to construct and assemble the towing hitch assembly 100.

FIG. 12 also illustrates a plurality of safety apertures 160 disposed on the perimeter of the cross-member 105. The safety apertures 160 are configured to receive attachment elements of trailer safety chains. For example, to ensure a trailer is securely attached to the receiver 140 of a hitch cross-member assembly 100, chains can be hooked to the safety aperture 160 as a safety precaution should the receiver 140 and the trailer attachment become detached. The safety apertures 160 can be disposed anywhere along the cross-member 105 such that safety chains from a trailer can be attached or hooked onto the safety apertures 160. For example, in FIG. 12, a plurality of safety apertures 160 is disposed on the cross-member 105 on either side of the receiver 140. While a plurality of safety apertures 160 is illustrated in FIG. 1, one of ordinary skill in the art will appreciate that the towing hitch assembly 100 can include one safety aperture 160 or no safety apertures, as shown in FIGS. 4, 7-10, and 23.

FIG. 12 also illustrates two mounting members 125 that can be coupled to the cross-member 105 and configured to mount the cross-member 105 to a vehicle. When the towing hitch assembly 100 is assembled, a coupling 165 (for example, as shown in FIGS. 9, 11, and 23) can secure the mounting members 125 to the cross-member 105. For example, the coupling 165 can be a welded, an adhesive coupling, a brazed coupling, a bonding compound coupling a combination of an adhesive coupling and a welded coupling (shown in FIG. 12), or other similar couplings that can permanently secure the mounting member 125 to the cross-member 105 or that can secure the mounting member 125 to the cross-member 105 to allow the towing hitch assembly 100 to handle a load from a trailer. In an alternative embodiment, the mounting members 125 can include a lip 150 formed at an edge of the mounting member 125 and at least one mounting aperture 155. The lip 150 can abut the frame of a vehicle to ensure a suitable coupling between the towing hitch assembly 100 and the vehicle. The mounting apertures 150 allow for bolted attachments, screw attachments, or other attachments that can secure the towing hitch assembly 100 to a vehicle. In other embodiments, the mounting member 125 can be coupled to the vehicle without a lip 150 as illustrated. For example, the mounting member 125 can be bolted to a frame of the vehicle or welded to the vehicle. In yet other embodiments, the cross-member 105 can itself be coupled directly to the vehicle.

FIGS. 13-16 are views of the towing hitch assembly 100 as depicted in FIG. 12 in an assembled configuration. FIG. 13 is a front perspective view of the towing hitch assembly illustrated in FIG. 12 in an assembled configuration. As seen in FIG. 13, the receiver 140 is inserted into the slot 190 and rests on a top portion of the cross-member 105. By coupling the receiver 140 at the top of the cross-member 105, the cross-member 105 can provide support, reinforcement, and rigidity for the towing hitch assembly 100 when a trailer is attached to and exerts a load on the towing hitch assembly 100. FIG. 13 also illustrates the receiver 140 coupled at the center of the cross-member 105. By coupling the receiver 140 at the center of the cross-member 105, the towing assembly 100 ensures that a trailer will be centered and substantially directly aligned with the vehicle when the trailer pulled by the towing assembly 100. However, in alternative embodiments, the slot 190 can be disposed anywhere on the cross-member 105 such that a receiver 140 can receive a trailer attachment and permit the towing hitch assembly 100 to safely pull or tow the attached trailer. In either embodiment, a coupling 170 can couple the receiver 140 to the cross-member 105. The coupling 170 can be a welded coupling, an adhesive coupling, a bonded coupling, a combination of a welded and adhesive coupling, or any other coupling that permits receiver 140 to remain attached to the cross-member 105 when a trailer is attached to the receiver 140 and that permits the towing hitch assembly 100 to handle a load exerted by pulling the attached trailer.

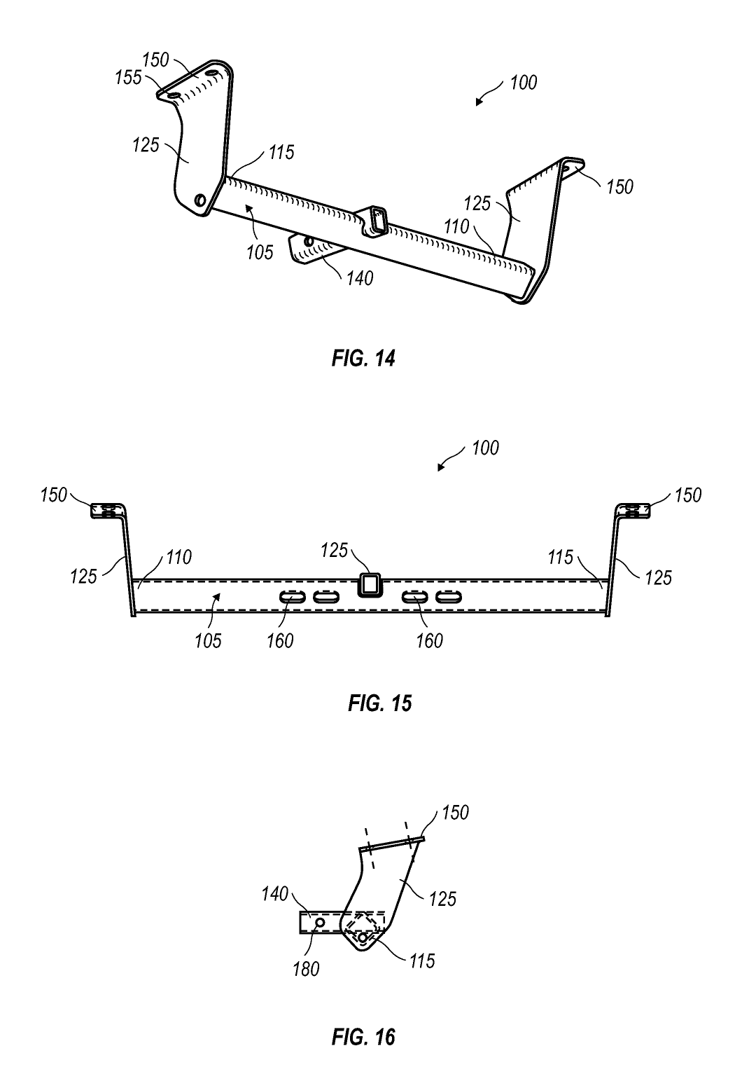

FIG. 14 is a rear perspective view of the towing hitch assembly 100 illustrated in FIG. 13 having the receiver 140 coupled to a top portion of the cross-member 105. The receiver 140 is coupled to the cross-member 105 such that the receiver 140 is substantially perpendicular to a longitudinal axis of the cross-member 105. As illustrated in FIG. 14, a distal end of the receiver 140 extends beyond the cross-member 105. However, in alternative embodiments, the receiver 140 can be coupled to the cross-member 105 such that a bottom of the distal end of the receiver 140 is flush with a perimeter or surface of the cross-member 105. FIG. 15 is a front view of the towing hitch assembly 100 illustrated in FIG. 13. In FIG. 15, the receiver 110 is inserted into the slot 190 such that the receiver 140 is coupled to the top surface and top portion of the cross-member 105. FIG. 16 is a side view of an end portion the towing hitch assembly 100 as illustrated in FIG. 2. Specifically, FIG. 16 shows a side view of the towing hitch assembly 100 facing the second distal end 115. FIG. 16 further illustrates the position of the receiver 140 when it is coupled to a cross-member 105 having a slot disposed at the top surface of the cross-member 105.

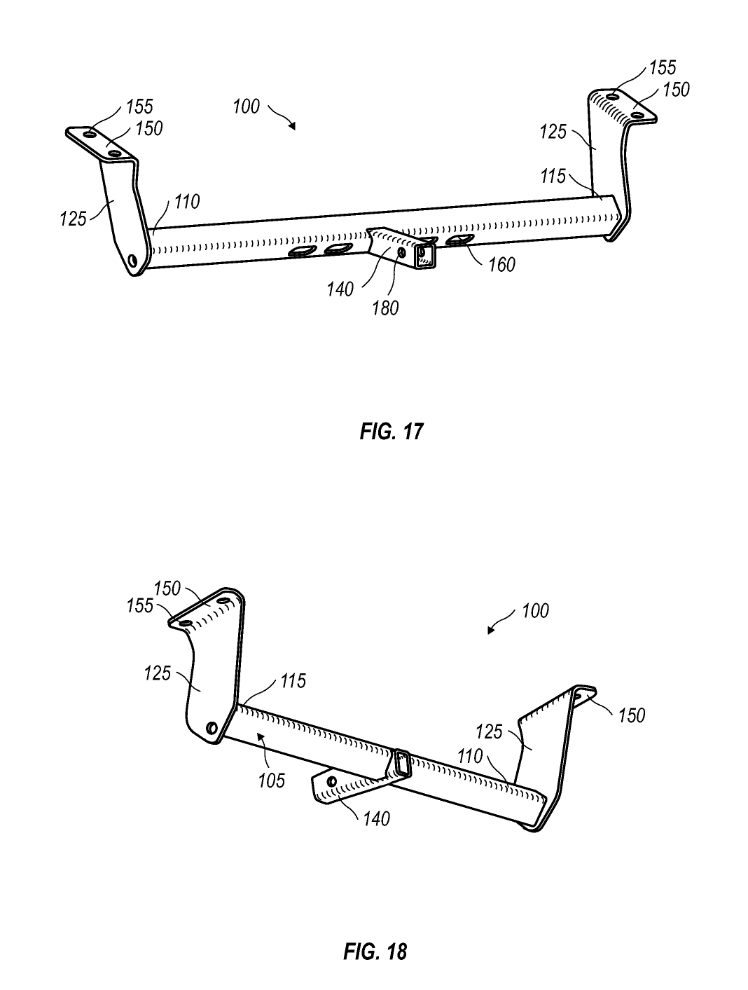

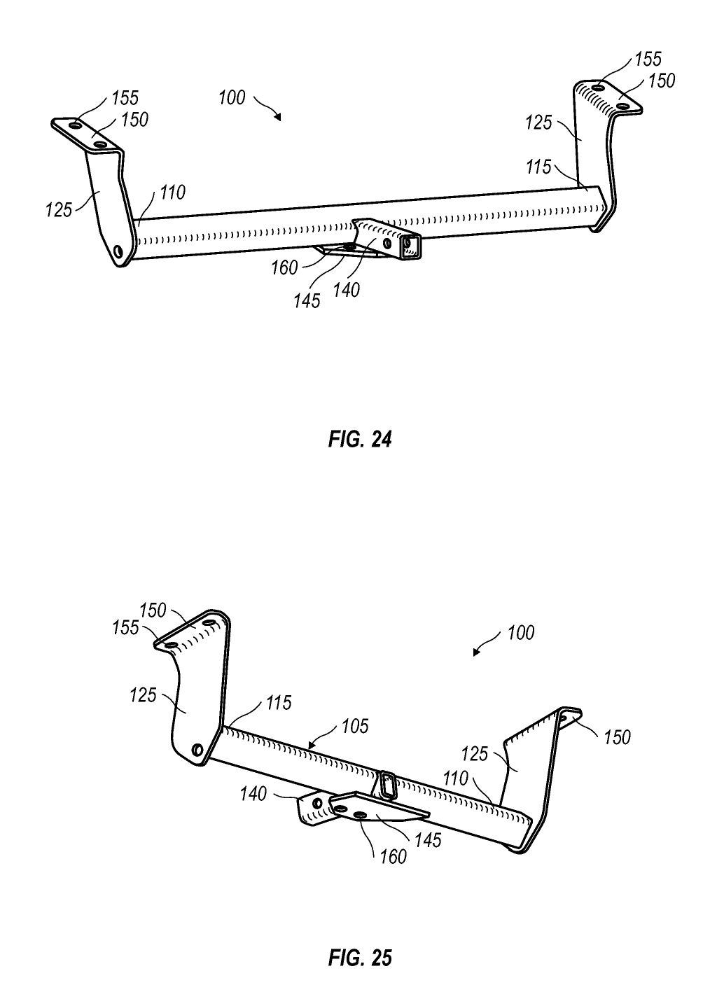

FIGS. 17-20 illustrate an alternative embodiment of a towing hitch assembly 100 having the receiver 140 coupled at a bottom portion of the cross-member 105. FIG. 17 is a front perspective view of a towing hitch assembly 100 in an assembled configuration. In FIG. 17, the cross-member 105 has a first distal end 110, a second distal end 115, and a slot (not shown) disposed in between the first distal 110 and second distal 115 ends at the bottom surface of the cross-member 105. The slot is configured to receive a receiver 140. As the receiver 140 is configured to be inserted into the slot, the receiver 140 and the slot will have corresponding shapes. As described above, the receiver 140 can have a square cross-section (shown in FIG. 17), a circular cross-section, a rectangular cross-section, or any other shaped-cross section that permits a trailer to be attached to the receiver 140 and permits the receiver 140 to withstand a load exerted by the attached trailer. The slot can have a shape that accommodates and corresponds to the shape of the receiver 140. A coupling 170 can couple the receiver 140 to the cross-member 105. The coupling 170 can also reinforce the strength of the receiver 140 to ensure the receiver 140 remains connected to the cross-member 105 when a trailer is attached to and exerts a load on the receiver 140. The coupling 170 can be a welded coupling, an adhesive coupling, a combination of both a welded coupling and an adhesive coupling, a reinforcement plate coupling (shown in FIGS. 24 and 25), or any other coupling that ensures the receiver 140 remains connected to the cross-member 105 when a trailer is attached to and exerts a load on the receiver 140. In FIG. 17, the receiver 140 is coupled to the cross-member 105 at a bottom portion of the cross-member 105. In this configuration, when a trailer is attached to the receiver 140 and exerts a load on the receiver 140, that load will also be exerted at the point where the receiver 140 joins the cross-member 105.

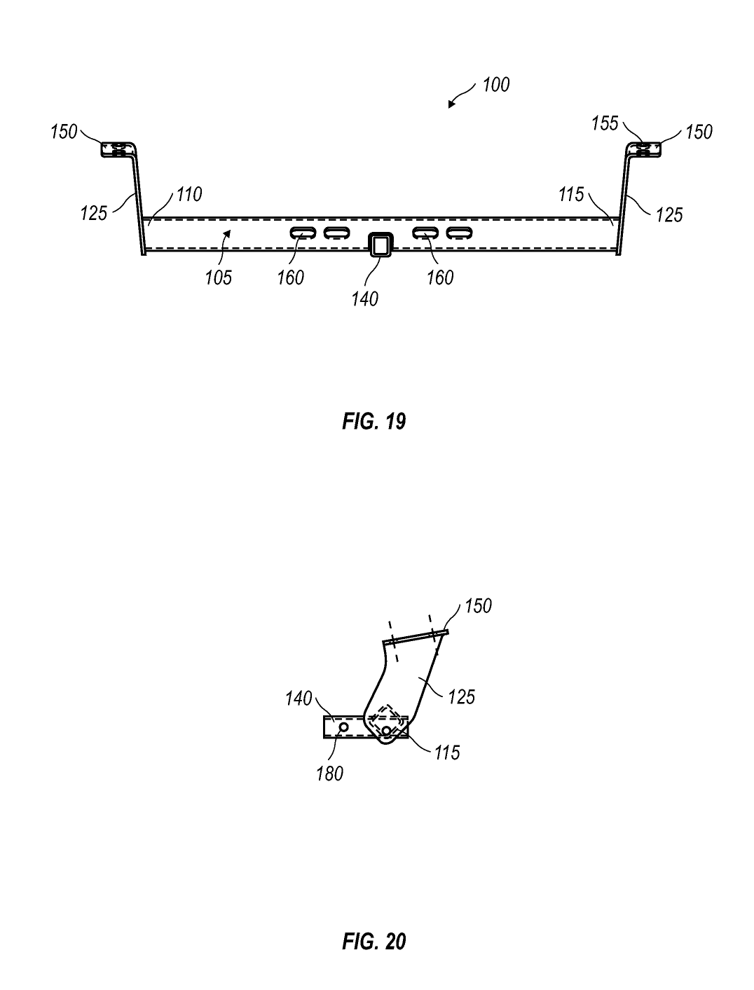

FIG. 18 is a rear perspective view of the towing hitch assembly 100 illustrated in FIG. 17. As illustrated in FIG. 18, the receiver 140 is coupled to the cross-member 105 at a bottom portion of the cross-member 105. The receiver 140 is coupled such that is it substantially perpendicular to a longitudinal axis of the cross-member 105. In FIG. 18, a distal end of the receiver 140 extends beyond the cross-member 105. However, in alternative embodiments, the receiver 140 can be coupled to the cross-member 105 such that a bottom portion of the distal end of the receiver 140 is flush with a perimeter or surface of the cross-member 105. FIG. 19 is a front view of the towing hitch assembly 100 illustrated in FIG. 17. In FIG. 19, the receiver 140 is inserted into the slot 190 such that the receiver 140 is coupled to the bottom surface and bottom portion of the cross-member 105. FIG. 20 is a side view of an end portion the towing hitch assembly 100 as illustrated in FIG. 17. Specifically, FIG. 20 shows a side view of the towing hitch assembly 100 facing the second distal end 115. FIG. 20 further illustrates the position of the receiver 140 when it is coupled to a cross-member 105 having a slot disposed at the bottom surface of the cross-member 105.

FIGS. 21 and 22 illustrate a towing assembly 100 having a slotted cross-member 105 in accordance with alternative embodiments. FIG. 21 illustrates a towing hitch assembly 100 comprising a cross-member 105 having a first distal end 110 and a second distal end 115, a receiver 140 inserted into a slot disposed between the first distal and second distal ends 110, 115, and mounting members 125 coupled to each of the first distal and second distal ends 110, 115. FIG. 21 also illustrates a cross-member 105 having a square cross-section.

FIG. 22 illustrates a towing hitch assembly 100 comprising a cross-member 105 having a first distal end 110 and a second distal end 115, a receiver 140 inserted into a slot (not shown) disposed between the first distal and second distal ends 110, 115, and mounting members 125 coupled to each of the first distal and second distal ends 110, 115. FIG. 22 illustrates a cross-member 105 having a circular cross-section. Also illustrated in FIG. 22, a ring 199 is provided on either side of the receiver 140. In the illustrated example, the rings 199 are formed on uniform plate coupled to a bottom surface of the receiver 140. However, in alternative embodiment, the rings 199 can be separate pieces coupled to the bottom surface of the receiver 140. In at least one embodiment, the rings 199 can be welded to the receiver 140, integrated with the receiver 140, adhered to the receiver 140, or coupled to the receiver 140 by any other means of attachment for securely coupling the rings 199 to the receiver 140. The rings 199 can provide an opening for receiving hooks, chains, or other components of an object to be coupled to the cross-member assembly 100. The rings 199 allow for the secured coupling of an object to be towed by a vehicle to the cross-member assembly 100. While the embodiment in FIG. 22 illustrates the rings 199 coupled to the bottom surface of the receiver 140, the rings 199 can be coupled to the upper surface of the receiver 140 or on the side surfaces of the receiver 140. Additionally, while each ring 199 illustrated in FIG. 22 includes one opening, it will be appreciated that fewer or more openings can be provided on each ring 199 than as illustrated. Additionally, the rings 199 can be attached to any one of the embodiments described herein.

FIG. 23 is a front perspective view of a towing hitch assembly 100 in accordance with an alternative exemplary embodiment. As illustrated in FIG. 23, the towing hitch assembly 100 comprises a cross-member 105 having a first distal end 110 and a second distal end 115. A receiver 140 has been inserted into the slot (not shown) of the cross-member 105. In the particular embodiment illustrated in FIG. 23, the slot is disposed proximate the center of first distal end 110 and the second distal end 115. The slot is disposed substantially perpendicular to a longitudinal axis of the cross-member 105. A coupling 170 can couple the receiver 140 to the cross-member 105. In FIG. 23, the coupling 170 is a welded coupling, but the coupling 170 can also be an adhesive coupling, a combination of adhesive and welding, or any other coupling 170 that ensure the receiver 140 will remain attached to the cross-member 105 when a trailer is attached to and exerts a load on the towing hitch assembly 100.

FIG. 23 also illustrates a mounting member 1250 coupled to each of the first distal end 110 and the second distal end 115 of the cross-member 105. The mounting members 125 are configured to mount the cross-member 105 to a frame of a vehicle. In FIG. 23, the mounting member 125 comprises a lip 150 formed at a top edge of the mounting member 125. The lip 150 is configured to abut the frame of a vehicle and to mount the cross-member assembly 100 to the vehicle. In FIG. 23, the lip 150 is an L-shaped bend formed at a top portion of the mounting member 125. In alternative embodiments, the lip 150 can be an additional plate that is mounted or welded to the mounting member 125. While the lip 150 as illustrated is substantially flat, in other embodiment, the lip 150 is shaped so as to conform to the portion of the frame for which it is attached. In yet other embodiments no lip 150 may be included as the mounting member can be secured directly to the frame. In further alternative embodiments, the mounting member 140 can be mounted to the frame by being integrated with the vehicle frame, welded to the vehicle frame, adhesively bonded to the vehicle frame, or mounted to the frame by any other suitable configuration

As illustrated in FIG. 23, the lip 150 can, but does not need to, include a plurality of mounting apertures 155. The mounting apertures 155 can be configured for bolting, screwing, mounting, or otherwise securing the cross-member assembly 100 to the vehicle. The mounting member 125 can be coupled to each of the distal ends 110, 115 by a coupling 185. In FIG. 23, the mounting member 125 is coupled to the cross-member 105 by a welded coupling. In an alternative embodiments, the coupling 165 can be an adhesive coupling, a brazed coupling, a bonding compound coupling a combination of an adhesive coupling and a welded coupling, or other similar couplings that can permanently secure the mounting member 125 to the cross-member 105 or that can secure the mounting member 125 to the cross-member 105 to allow the towing hitch assembly 100 to handle a load from a trailer. In at least one embodiment, the towing hitch assembly can comprise the slotted cross-member illustrated in FIGS. 12-25 with mounting members 125 mounted to the cross-member 105 but protuberances 135 and notches 120 as illustrated in FIGS. 1-11.

FIGS. 24 and 25 illustrate a towing hitch assembly 100 having a slotted cross-member 105, in accordance with an alternative exemplary embodiment including a reinforcement plate 145. FIG. 24 is a front perspective view of the towing hitch assembly 100 having a reinforcement plate 145. FIG. 25 is a rear perspective view of the towing hitch assembly 100 having a reinforcement plate 145. In FIGS. 24 and 25, the illustrated receiver 140 is coupled to a bottom portion of the cross-member 105 such that an end portion of the receiver 140 juts out or extends beyond perimeter of the cross-member 105. A reinforcement plate 145 can be coupled to one of the cross-member 105 and the receiver 125 and is configured to be proximate and parallel to the receiver 140. The reinforcement plate 145 can provide reinforcing strength for the receiver 140 when a trailer is attached to and exerts a load on the receiver. FIGS. 24 and 25 illustrate the reinforcement plate 145 is coupled to both the receiver 140 and the cross-member 105. However, one of ordinary skill in the art will appreciate that the reinforcement plate 145 can be coupled to the cross-member 105 alone. FIGS. 24 and 25 also illustrate a reinforcement plate 145 having safety apertures 160 disposed on the plate 145. In at least one embodiment, the safety apertures 160 on the plate 145 can be in addition to the safety apertures 160 in the cross-member 105.

A method of constructing a towing hitch assembly 100 having a slotted cross-member as described above will be described in the following paragraphs with respect to the embodiment illustrated in at least FIGS. 12 and 13. While the following method is described with respect to the exemplary towing hitch assembly 100 illustrated in FIG. 12, other components as described above can be included in the method and constructed as appropriate. The method of constructing the towing hitch assembly 100 can include providing a tube and at least one plate. The tube can be constructed to form the cross-member 105. The method of constructing a towing hitch assembly 100 can also comprise cutting a slot 190 through the tube in between a first distal end 110 and a second distal end 115 of the tube such that the slot 120 is substantially perpendicular to a longitudinal axis 200 of the tube and is shaped to receive a receiver 140. The slot 190 can be cut in the center of the tube at either the top surface of the cross-member 105 (shown in FIG. 12) or the bottom surface of the cross-member 105 (shown in FIG. 17). However, one of ordinary skill in the art will appreciate that the slot 190 can be cut anywhere along the tube or cross-member 105 such that a receiver 140 can be inserted in the slot 190 such that the slot is substantially perpendicular to the longitudinal axis 200 of the cross-member 105 and such that a trailer can be attached to the towing hitch assembly 100. Cutting a slot 190 through the cross-member 105 can be accomplished by a laser cutting process, a milling technique, a laser machining process, or any other similar precision machining or precision cutting process. Using a precision machining or precision cutting process can ensure accurately sized cuts and can maintain the material strength of the tube when cut.

The method can also comprise inserting and aligning the receiver 140 in the slot 190 and securing a coupling 170 between the tube and the receiver 140. The receiver 140 can be inserted into the slot 190 such that an end portion of the receiver 140 extends beyond the perimeters of the cross-member 105, as illustrated in FIGS. 13 and 14. In alternative embodiments, the receiver 140 can be inserted into the slot 190 such that an end portion of the receiver 140 is flush with the perimeter of the cross-member 105.

Securing a coupling between the tube and the receiver 140 can comprise welding the tube and receiver 140, as illustrated in FIG. 23. In alternative embodiments, securing the coupling 170 can comprise securing the tube and receiver 140 by an adhesive coupling, a combination of adhesive and welding, or any other coupling 170 that ensure the receiver 140 will remain attached to the cross-member 105 when a trailer is attached to and exerts a load on the towing hitch assembly 100.

The method of constructing a towing hitch assembly 100 can further comprise coupling a mounting member 130 to one of the first distal end 110 and the second distal end 115 of the tube. For example, coupling a mounting member 125 can comprise welding the tube to the mounting member 125 at a location where a surface of the distal end 110, 115 is flush with the mounting member 125. In FIG. 23, the mounting member 125 is welded to the cross-member 105 where the perimeter of the second distal end 115 is flush with the mounting member 125. A similar coupling can be made between the cross-member 105 and the mounting member 125 where the perimeter of the first distal end 110 is flush with a surface of the mounting member 125. While FIG. 23 illustrates securing a coupling by welding, one of ordinary skill in the art will appreciate that securing a coupling can also include adhesively coupling the tube and the mounting member, bonding the tube and the mounting member, a combination of both welding and adhesively coupling the tube and the mounting member, or any other coupling that permits the cross-member assembly 100 to remain mounted to a vehicle when a load is exerted by a trailer attached to receiver member 140 of the cross-member assembly 100.

The method for constructing a towing hitch assembly 100 can also include forming a lip 150 on an edge of the mounting member 125, as illustrated in at least FIG. 12. The lip 150 can be formed by heating and edge of the mounting member 125 and the bending the edge such that the lip 150 is substantially perpendicular to the rest of the mounting member 125. One of ordinary skill in the art will appreciate that other methods of bending or forming a plate can be used to form the lip 150 on an edge of the mounting member 125. As a result of including a lip 150 on the mounting member 125, a mounting bracket is formed and configured to mount the towing hitch assembly 100 to a vehicle. While the illustrated embodiments show a lip 150 formed substantially perpendicularly to the rest of the mounting member 125, one of ordinary skill in the art will appreciate that the lip 150 can form any angle with the rest of the mounting member 125 to permit the mounting of the towing hitch assembly 100 to a vehicle. In another alternative embodiment, at least one mounting aperture 155 can be cut out of the lip 150 as illustrated in at least FIG. 23. The mounting aperture 155 can be cut out of the mounting member 125 by laser cutting, milling, laser machining, or any other similar precision cutting or precision machining. In other embodiments, the mounting member 125 can be coupled to the vehicle without a lip 150 as illustrated. For example, the mounting member 125 can be bolted to a frame of the vehicle or welded to the vehicle. In yet other embodiments, the cross-member 105 can itself be coupled directly to the vehicle.

The method of constructing a towing hitch assembly 100 can also comprise cutting at least one safety aperture 160 on the towing hitch assembly 100. For example, at least one safety aperture 160 can be cut on a perimeter of the tube, wherein the at least one safety aperture 160 is located in between the first distal end 110 and the second distal end 115 of the tube. In FIGS. 12-22, the at least one safety aperture 160 is cut out of the perimeter of the tube on either side of a receiver 140. In alternative embodiments, the at least one safety aperture 160 can be cut out anywhere along tube such that safety chains from a trailer can be attached or hooked to the at least one safety aperture 160. In at least one embodiment, the at least one safety aperture 160 is located substantially proximate to the location where the receiver 140 is coupled to the cross-member 105. Additionally, the at least one safety aperture 160 can be mounted substantially centered on a face of the cross-member 105. In yet other embodiments, the safety aperture 160 is configured so as to allow easy access to the at least one safety aperture 160 when behind the vehicle to which the towing hitch assembly 100 is mounted. In the illustrated embodiment, four safety apertures are shown so as to allow a hook (not shown) of the safety chain to be inserted into one safety aperture 160 and exit out of an adjacent safety aperture 160 so as to secure the safety chain to the towing hitch assembly 100. While a plurality of safety apertures 160 are illustrated in FIGS. 12-22, one of ordinary skill in the art will appreciate that the towing hitch assembly 100 can include one safety aperture 160 or no safety apertures. In either embodiment of the method including forming at least one safety aperture 160 on the towing hitch assembly 100, one of ordinary skill in the art will also appreciate that the at least one safety aperture 160 can be cut out of the perimeter of the tube by laser cutting, milling, laser machining, or any other similar precision cutting or precision machining.

The method of constructing a towing hitch assembly 100 can also comprise coupling a reinforcement plate 145 to one of the tube and the receiver 140. The reinforcement plate 145 can be coupled to the cross-member 105 such that reinforcement plate 145 is configured to be proximate and parallel to the receiver 140. In alternative embodiments, the reinforcement plate 145 can be coupled directly to the receiver 140, can be coupled to the cross-member 105 on either side of the receiver 140, can be coupled to a surface of the cross-member 105 opposite the receiver 140, or can be coupled anywhere on the cross-member 105 such that reinforcement plate 145 is proximate to the receiver 140. The method of constructing a towing hitch assembly 100 having a reinforcement plate 160 can comprise cutting at least one safety aperture 160 through the reinforcement plate 160. In FIGS. 24 and 25, two safety apertures 160 are cut through the reinforcement plate 145 proximate a distal edge of the reinforcement plate 145. However, one of ordinary skill in the art will appreciate that a single safety aperture 160 can be cut through the reinforcement plate 145. One of ordinary skill in the art will also appreciate that the at least one safety aperture 160 can be cut anywhere on the reinforcement plate 145 such that safety chains from a trailer can be coupled to the towing assembly 100 when a trailer is attached to the towing assembly 100. As discussed above, the safety apertures 160 can be cut by laser cutting, milling, laser machining, or any other similar precision cutting or precision machining.

With the towing hitch assembly 100 having a slotted cross-member and the method of constructing the towing hitch assembly 100 as described herein, tack welds, clamping components, or other elements required to preliminarily secure the alignment of the cross-member 105 and the receiver 140 prior to making a final or complete weld to join the components can be eliminated. Since the slot 190 of the cross-member 105 is configured to correspond to the shape of a receiver 140 and is configured to receive the receiver 140, the engagement between the slot 190 and the receiver 140 can ensure the secured alignment of the cross-member 105 and the receiver 140. When the receiver 140 is inserted into the slot 190, a final weld or a final secured coupling can be made where the cross-member 105 and the receiver 140 join. It is not necessary to tack weld or preliminary couple the cross-member 105 and the receiver 140 before making the final weld or the final secured coupling to complete the assembly of the towing hitch assembly 100 having a slotted cross-member. Thus, a less-cumbersome and more efficiently constructed towing hitch assembly is provided that requires less time, less manufacturing, and fewer components to assemble the towing hitch assembly 100.

With the towing hitch cross-member assembly 100 described herein and the method of constructing the towing hitch cross-member assembly 100, tack welds, clamping components, or other elements required to preliminarily secure the alignment of the cross-member 105 and mounting member 125 prior to make a final or complete weld can be eliminated. In at least one embodiment wherein the cross-member 105 and the mounting member 125 are coupled via protuberances 135 and notch 120, since the at least one notch 120 of the cross-member 105 and the at least one protuberance 135 of the mounting member 125 matingly engage and secure the alignment of the cross-member 105 and the mounting member 125, a final weld or a final secured coupling can be made where the cross-member 105 and the mounting member 125 join. It is not necessary to tack weld or preliminary couple the cross-member 105 and the mounting member 125 before making the final weld or the final secured coupling to complete the assembly of the towing hitch cross-member assembly 100 having self-locating tabs. Thus, a less-cumbersome and more efficiently constructed towing hitch assembly is provided that requires less time, less manufacturing, and fewer components to assemble the towing hitch assembly. The strength of the towing hitch cross-member assembly 100 is also enhanced because of the mating engagement between the at least one notch 120 of the cross-member 105 and the at least one protuberance 135 of the mounting member 125.

After the cross-member assembly 100 has been constructed and assembled, the cross-member assembly 100 can be mounted onto a vehicle and can receive a trailer attachment element of a trailer. An exemplary embodiment of mounting the cross-member assembly 100 in accordance with the embodiment described herein can include aligning the lips 150 of the cross-member assembly 100 with the frame of a vehicle. The cross-member assembly 100 can then be secured to the vehicle by screws or bolts fed through the mounting apertures 155 of the lips 150. A trailer attachment element can then be received by the receiver 140 and secured to the receiver 140 by a pin, nut and bolt, or other securing attachment. Safety chains attached to the trailer can also be received by the safety apertures 160 of the cross-member assembly to further ensure that the trailer is secured to the cross-member assembly in case the trailer attachment element and the receiver 140 become detached or decoupled.

One of ordinary skill in the art will appreciate that the features in each of the figures described herein can be combined with one another and arranged to achieve the described benefits of the presently disclosed cross-member assembly. Additionally, one of ordinary skill will appreciate that the elements and features from the illustrated implementations herein can be optionally included to achieve the described benefits of the presently disclosed cross-member assembly. Various modifications to and departures from the disclosed implementations will occur to those having skill in the art. The subject matter that is intended to be within encompassed by the disclosure is set forth in the following claims.

1. A cross-member assembly for use with a hitch for a vehicle, said cross-member assembly comprising:
an elongate cross-member configured to be stationarily coupled to the vehicle, said cross-member comprising a first distal end and a second distal end, and wherein at least one notch is disposed on at least one of the first distal end and the second distal end; and
wherein the at least one notch is configured to be matingly engaged with a protuberance disposed on a mounting member when one of the first distal end and the second distal end of the cross-member is received by the mounting member.

2. The cross-member assembly as recited in claim 1, wherein the at least one notch is a pair of notches and each notch of the pair of notches is oppositely disposed from the other on the distal end of the cross-member.

3. The cross-member assembly as recited in claim 1, wherein the at least one notch has one of a rounded shape, a square shape, a triangular shape, and a rectangular shape.

4. The cross-member assembly as recited in claim 1, wherein the elongate cross-member has one of a circular cross-section, a rectangular cross-section, a square cross-section, and a diamond cross-section.

5. (canceled)

6. The cross-member assembly as recited in claim 1, wherein the mounting member has an aperture configured to receive one of the first distal end and the second distal end of the cross-member, and wherein the pair of protuberances is formed on the aperture.

7. The cross-member assembly as recited in claim 6, wherein the protuberance has one of a rounded shape, a square shape, a triangular shape, and a rectangular shape.

8. The cross-member assembly as recited in claim 6, wherein the aperture is shaped to correspond to a cross-sectional shape of one of the first distal end and the second distal end of the cross-member.

9. (canceled)

10. The cross-member assembly as recited in claim 1 further comprising a receiver perpendicularly coupled to the cross-member in between the first distal end and the second distal end of the cross-member.

11. The cross-member assembly as recited in claim 10, wherein the receiver is coupled to the cross-member by a coupling chosen from the group consisting of: welding the receiver to the cross-member, mounting the receiver to the cross-member by a receiver plate, and integrating the receiver with the cross-member.

12. The cross-member assembly as recited in claim 1, wherein the mounting member further comprises a lip formed at an edge of the mounting member.

13. The cross-member assembly as recited in claim 12, wherein the lip includes at least one mounting aperture.

14. The cross-member assembly as recited in claim 1, wherein the cross-member further comprises at least one safety aperture disposed in between the first distal end and the second distal end.

15. The cross-member assembly as recited in claim 14, wherein the at least one safety aperture is disposed on a mounting plate configured to couple a receiver to the cross-member.

16-26. (canceled)

27. A towing hitch assembly comprising:
an elongate cross-member configured to be mounted to a vehicle, said cross-member having a first distal end and a second distal end and further comprising a slot disposed in between the first distal end and the second distal end, said slot disposed perpendicularly to a longitudinal axis of the elongate cross-member; and
a receiver configured to be inserted in the slot of the cross-member.

28. The towing hitch assembly as recited in claim 27 further comprising at least one safety aperture disposed on a perimeter of the cross-member.

29-32. (canceled)

33. The towing hitch assembly as recited in claim 27 further comprising a reinforcement plate coupled to one of the cross-member and the receiver, wherein the reinforcement plate is configured to be proximate and parallel to the receiver.

34. The towing hitch assembly as recited in claim 33, wherein the reinforcement plate comprises at least one safety aperture disposed proximate to a distal edge of the reinforcement plate.

35. The towing hitch assembly as recited in claim 27, wherein the slot is disposed on one of a top surface and a bottom surface of the cross-member.

36.-48. (canceled)
